(19) United States
(12) Patent Application Publication
(10) Pub. No.: US 2010/0024010 A1
(43) Pub. Date: Jan. 28, 2010

(54) Mobile device with customizable login screen

(76) Inventors: Ernest Samuel Baugher, Buda, TX (US); Venkata Chalapathi Majeti, Naperville, IL (US); Suresh Neelagaru, Amarillo, TX (US)

Correspondence Address: Carmen Patti Law Group , LLC, ONE N. LASALLE STREET, 44TH FLOOR, CHICAGO, IL, 60602, US

(21) Appl. No.: 12/220,137

(22) Filed: Jul. 22, 2008

(51) Int. Cl. H04L 9/32

(52) U.S. Cl. 726/5

(57) ABSTRACT

An exemplary method controls the display of information on the screen of a mobile device during a request for login information. Independently controlled regions of the screens are used to concurrently convey different information associated with each region to a user of the mobile device during the rendering of a login request that is contained in one of the regions.

### BACKGROUND

This invention relates to mobile devices with an application program that requires a user to input an identification and/or password, and more specifically to the display of information on the screen of the mobile device while the user is prompted for such input.

Mobile devices that run application programs in which access is limited to authorized users will typically first display a login screen. The login screen provides an input template that prompts the user to enter indicated information. Such a login screen may include a user input area having a “user identification: ______” and a “password: ______”, where the blank space following the labels accepts user input of the requested corresponding information. The information supplied by the user will commonly consist of various ASCII characters, e.g. alphanumeric characters and/or defined ASCII symbols. Upon entering the requested information, the user will cause the information to be transmitted to and/or through the application program for verification. Assuming that the information is validated, the user will then be allowed to access the functions and data provided by the application program.

In the above-described example, the mobile device displays a single visual frame that defines the entire screen of the mobile device. This frame may include further information outside of the user input area, e.g. “—Welcome to the XYZ Program on {date}—”. This information and the user input area are controlled by a single entity and rendered as a single graphic frame that defines the information presented on the entire screen of the mobile device while prompting for the input of login information. This approach has generally proved satisfactory in the collection of required login information.

### SUMMARY

It is an object of the present invention to satisfy the need for greater flexibility in the control and presentation of information to a user as part of a login screen.

An exemplary method controls the display of information on the screen of a mobile device. On a first region of the screen, first login request information generated under the control of a first application program from a first source is displayed. The login request information is to be utilized to validate a user as having been previously registered via the first application program. Second and third information obtained from second and third sources are accessed, respectively, where the content of the second and third information is controlled independent of the first application program. The second and third information is displayed within second and third regions of the screen, respectively. The first, second and third information are concurrently displayed to the user in the first, second and third regions. Each of the regions occupy separate predetermined nonoverlapping horizontal segments of the screen, where information obtained from the second and third sources exclusively define information to be displayed in the respective second and third segments.

### DESCRIPTION OF THE DRAWINGS

Features of exemplary implementations of the invention will become apparent from the description, the claims, and the accompanying drawings in which:

FIG. 1 is a block diagram of an exemplary system suited for support of a mobile device that incorporates an embodiment of the present invention.

FIG. 2 is a block diagram of an exemplary wireless mobile device in accordance with an embodiment of the present invention.

FIG. 3 is a partial view of the front of an exemplary mobile device in accordance with an embodiment of the present invention.

FIG. 4 is a flow chart illustrating steps of an exemplary method in accordance with an embodiment of the present invention of an initial registration.

FIG. 5 is a flow chart illustrating steps of an exemplary method in accordance with an embodiment of the present invention of the display of information during the login screen and acceptance of user input.

### DETAILED DESCRIPTION

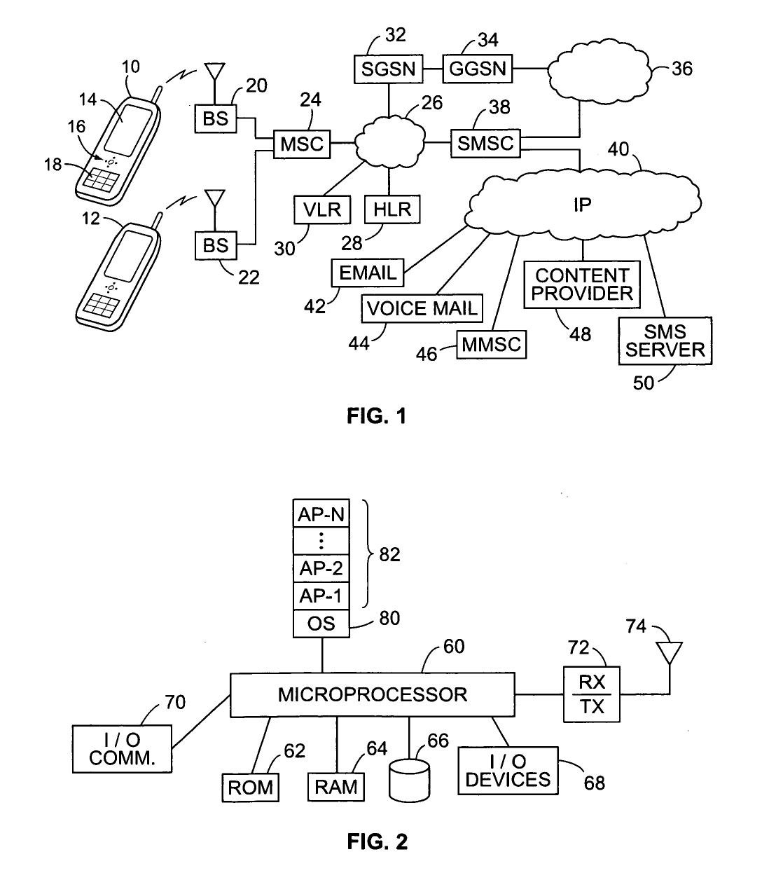

Referring to FIG. 1, an exemplary telecommunication network includes a system that supports wireless cellular subscribers with voice communications and short message service (SMS) messaging. First and second subscribers utilize mobile devices 10 and 12 such as a cellular telephone with SMS data capabilities. As used herein, a mobile device means a wireless portable two-way communications apparatus intended to be held in one hand during normal operation, e.g. a cellular telephone or personal digital assistant (PDA), and does not include a laptop computer. Each exemplary mobile device includes a display screen 14, user input controls 16 associated with cursor and screen control, and a keypad and/or keyboard 18 for accepting additional user inputs.

The system includes base stations (BS) 20 and 22 that support wireless communications between the devices 10 and 12, respectively, as controlled by a mobile switching center (MSC) 24. Signaling and data information are carried to and from the MSC by a supporting communication system 26, e.g. signaling system 7 (SS7). Also coupled to the system 26 is a home location register (HLR) 28 and a visiting location register (VLR) 30 which facilitate registration, authentication and location information related to the mobile devices.

In this illustrative example, communications are provided by a general public radio service (GPRS). Accordingly, communications with a serving GPRS service node (SGSN) 32 is also supported by system 26. Communications between the SGSN 32 and other networks 36, e.g. public switched telephone network (PSTN), general services mobile (GSM) network or code division multiple access (CDMA) network, is facilitated by a gateway GPRS service node (GGSN) 34.

An SMS controller (SMSC) 38 is coupled to system 26 and supports SMS communications among the mobile devices 10/12 and other devices which may be coupled to the internet protocol (IP) network 40. The mobile devices 10/12 may also support other communication services such as multimedia message service (MMS), email, a browser for internet access, and/or other data applications. A variety of services, functions and apparatus may be connected to the network 40. For example, servers or other appropriate nodes may provide email service 42 and voice mail service 44 for the mobile devices. A multimedia messaging service center (MMSC) 46 may provide support for multimedia communications, e.g. pictures or video information. A content provider server 48 is merely illustrative of the many possible sources of information which are available over the Internet. An SMS server 50 provides an interface between communications utilizing the SMS protocol and other communication protocols such as packets transmitted over the Internet.

FIG. 2 is a block diagram of an illustrative embodiment of a mobile device, e.g. mobile device 10. The functionality of the mobile device is provided by microprocessor 60 which is supported by read-only memory (ROM) 62, random access memory (RAM) 64, and nonvolatile memory 66 such as flash memory, EEPROM, etc. Input/output (I/O) devices 68 may include input devices such as a keypad, keyboard, touchpad, and other buttons such as for cursor movement, screen selection, etc., microphone, and an input port jack for wire-based communications with other devices. The output devices include a display screen 14 and a speaker. A separate microprocessor (not shown) can be dedicated to rendering the video display if the computational load for creating images is too high for the primary microprocessor 60 to handle in addition to the other demands. An input/output communication module 70 supports two-way communications between the microprocessor 60 and external devices such as connected by a cable to the input port jack, by infrared (IR) beam, or by Bluetooth technology. A transmit and receive module 72 coupled to antenna 74 provides radio frequency (RF) communication support with base stations and/or other wireless devices such as by Wi-Fi. The microprocessor 60 operates under the control of an operating system 80 which provides basic operational functionality and supports application programs 82 that provide higher-level functionality. The microprocessor in combination with associated memory and other peripheral devices form a microprocessing unit.

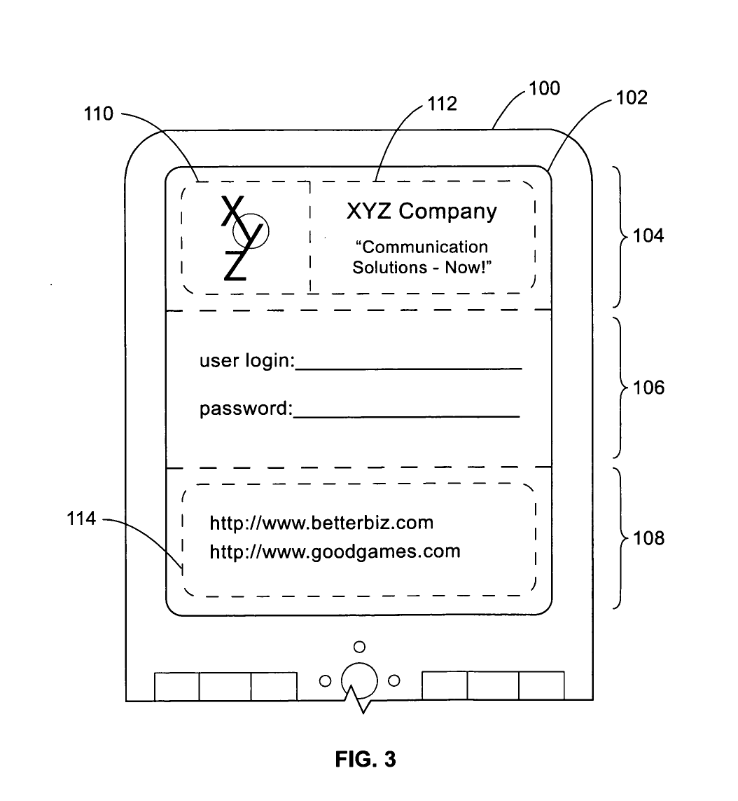

FIG. 3 is a partial front view of an exemplary mobile device 100 having a display screen 102. The display screen has an upper region 104, a middle region 106, and a lower region 108. Although the physical screen preferably comprises a single unitary area that includes all three of these regions, the information or indicia to be displayed is controlled on a region by region basis at least during the time during which the user is requested to login to a locally stored application program and/or a remote system. Each of the regions occupies separate predetermined nonoverlapping horizontal segments of the screen, where a segment is a horizontal width from the left edge to the right edge of the screen.

### FIRST EMBODIMENT

Assume that the user desires to login to a locally stored first application program and has previously clicked on a displayed icon associated with the first application program from a menu screen containing a plurality of different icons. Also assume that the mobile device is in wireless communications with one or more remote servers at this time. Information and/or indicia are displayed in the upper, middle, and lower regions as shown in FIG. 3 in accordance with this example. The information displayed in middle region 106 is controlled in accordance with the first application program and prompts the user to enter the user's login identification and password as part of the login process. Alternatively, if the mobile device is only intended for use by one person, the login identification can be stored locally or otherwise determined based on unique mobile device identifications, and hence the user need only be provided with a password prompt in region 106 during the login process. Although the operating system has granted the first application program the authority to control the entirety of the screen 100, the first application program has been configured to accept information and/or indicia from first and second sources for display in the upper region 104 and a lower region 108, respectively. In this example, the XYZ Company is the first source and has provided a graphical image of its corporate logo to be displayed in area 110 and alphanumeric characters to be displayed in area 112, all within the upper region 102 of the screen. The second source comprises a web based advertising company which has elected to display within area 114 of the lower region 108 two universal resource locator (URL) addresses, each having a hyperlink to a respective web site.

Because the operating system has granted the first application program control of the entire display screen, the information provided by the first and second sources for display in the respective regions is preferably temporarily stored in corresponding local memory locations accessible by the first application program during the creation of the frame to be displayed on screen 102, where the frame defines the content of each pixel contained in the entirety of screen 102. The first and second source control and define information to be displayed in the respective segments (regions) and the location of this information within the respective regions, independent of the first application program. That is, the first application program merely incorporates the provided information to be displayed in the upper and lower regions along with the middle region information which it generates in rendering the entire screen as shown in FIG. 3. Following the entry of the login information by the user, another screen view, consisting of the entirety of the screen, containing different information will be displayed to the user, where the latter screen preferably contains information generated entirely by another application program associated with the login information request. Thus, segregation of the screen into the upper, middle and lower regions is only provided during the login screen provided under control of the first application program. Thus, the displayed information as shown in FIG. 3 may be considered a “skin” that functions as a graphical user interface by the first application program.

If the user elects to click on one of the two hyperlinks in the lower region 108 instead of entering the login information in the middle region 106 (or before sending the entered information for validation), then the operating system will terminate control by the first application program and grant control to a browser residing on the mobile device in order to pursue communications with the web server associated with the selected hyperlink. In such a situation, the next screen will be displayed under the control of the browser wherein the browser will determine the frame to be displayed on the entire screen 102. The illustrative three regions may be displayed in a different sequence, e.g. regions 106 and 108 could be switched in location.

### SECOND EMBODIMENT

Assume that the user desires to login to a locally stored first application program and has previously clicked on a displayed icon associated with the first application program from a menu screen containing a plurality of different icons. Also assume that the mobile device is in wireless communications with one or more remote servers at this time. Information and/or indicia are displayed in the upper, middle, and lower regions as shown in FIG. 3 in accordance with this example. The information displayed in middle region 106 is controlled in accordance with the first application program and prompts the user to enter the user's login identification and password as part of the login process. The operating system has granted the first application program only the authority to control information and/or indicia to reside within the middle region 106 of the screen. The operating system has granted control to first and second sources to determine the information to be displayed in the upper region 104 and a lower region 108, respectively. In this example, the XYZ Company is the first source and has provided a graphical image of its corporate logo to be displayed in area 110 and alphanumeric characters to be displayed in area 112, all within the upper region 102 of the screen. The second source comprises a web based advertising company which has elected to display within area 114 of the lower region 108 two universal resource locator (URL) addresses, each having a hyperlink to the respective web site.

Because the operating system has granted the first application program, the first source and the second source control of the respective regions of the display screen, the respective information to be displayed provided by the first application program, the first source, and the second source is preferably stored in corresponding local memory locations accessible by the operating system for use during the creation of the frame to be displayed on screen 102, where the frame defines the content of each pixel contained in the entirety of screen 102. Following the entry of the login information by the user and a successful validation, the operating system grants control of the entire screen to an application program associated with the login information and another frame of information will be displayed to the user, where this frame contains information generated entirely by that application program, i.e. no information from the first and second sources will be displayed. Thus, segregation of the screen into the upper, middle and lower regions is only provided during the login process. If the user elects to click on one of the two hyperlinks in the lower region 108 instead of entering the login information in the middle region 106, then the operating system will grant control to a browser residing on the mobile device in order to pursue communications with the web server associated with the selected hyperlink, where the browser will control the entire screen.

### OTHER EMBODIMENTS

Additional variations may prove to be desirable. For example, it may be desirable to provide the user with the ability to customize at least some of the information displayed on the login screen as shown in FIG. 3. Instead of the first source having control of both areas 110 and 112 as described above, the first source could be given control of only area 112 and the user could be given control of area of 110. Prior to the user providing an input causing the login screen to be displayed, the user can be permitted to store personalized indicia in local memory of the mobile device or in a remote web site that is accessed as part of the generation of the login screen.

For example, the user may desire to store his picture that would be automatically displayed in area 110 on presentation of the login screen. In addition to display of the picture in area 110, the user's name or initials could also be displayed. In addition to personalizing the login display, the display of such information in area 110 would be useful in identifying the subject mobile device as belonging to the user associated with the information displayed an area 110. This would be especially useful in situations where a plurality of users share a common mobile device, or where a user loans his mobile device to another. Upon providing an input causing the generation of the login screen, the display of personal indicia in area 110 would remind another user operating the mobile device of the primary owner/user of the mobile device. If desired, login validation can be restricted to only the login identification and password of the user with the personal indicia displayed in area 110 by the application program and/or operating system. This can be accomplished by linking the stored personal indicia to be displayed an area 110 with the primary owner/user's login identification and password, and confirming that the entered login identification and password match the link information associated with the stored personal indicia, as well as providing further conventional authentication.

Further customization may be provided to the primary owner/user of the mobile device with regard to the information displayed in region 108 during the login screen display. For example, prior to the user providing an input causing the login screen to be displayed, the user may select one of a set of URL hyperlink addresses provided by the second source that will be displayed with an area 114 upon the display of the login screen. The selected addresses can either be stored in local memory of the mobile device or stored at a web site accessed as part of the generation on the login screen. Alternatively, if the user is the second source, any URL hyperlink addresses of the user's choosing can be stored in memory for later display during the rendering of the login screen. In the situation where the user is the second source, the user may elect to store any desired indicia to be displayed an area 114, where the desired indicia may be other than URL hyperlink addresses. For example, during the login process, the user may desire to have information presented in area 114 identifying other associates who are currently logged in to a remote web site. Depending upon who is currently shown to be logged in, the user may elect not to attempt a login if the presence of another is required or desirable to facilitate an activity and/or communications to be carried out through the user's login.

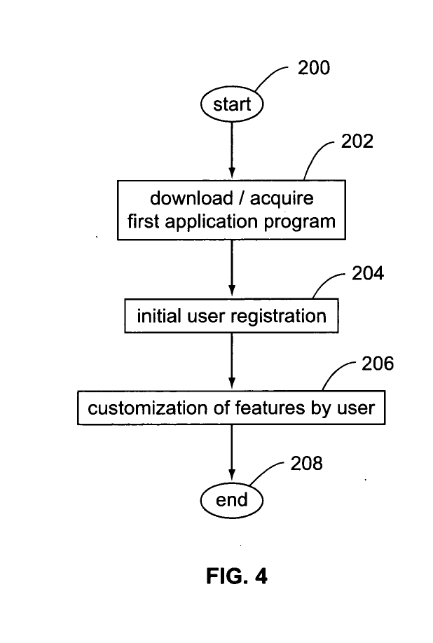

FIG. 4 is a flow diagram of steps in accordance with an exemplary method in accordance with the present invention illustrating an initial setup of the first application program. The method begins with START 200 typically based on a request entered by a user on his mobile device. In accordance with step 202 the first application program is downloaded or otherwise acquired by the user's mobile device. Upon the initial first time access by the user, the user will complete an initial user registration as indicated by step 204. This may include entry of the user's name, address, telephone number or other communication address associated with the user's mobile device, selection of a login identification name and corresponding password, and other information that may be relevant depending upon the subject matter and features associated with the first application program. In step 206 the user may be provided with the opportunity to customize certain features (such as explained above) associated with the login screen that will be presented to the user during the normal login process to the first application program. This may include the storing of alphanumeric information as well as graphical indicia, e.g. a picture of the user. This method terminates at END 208.

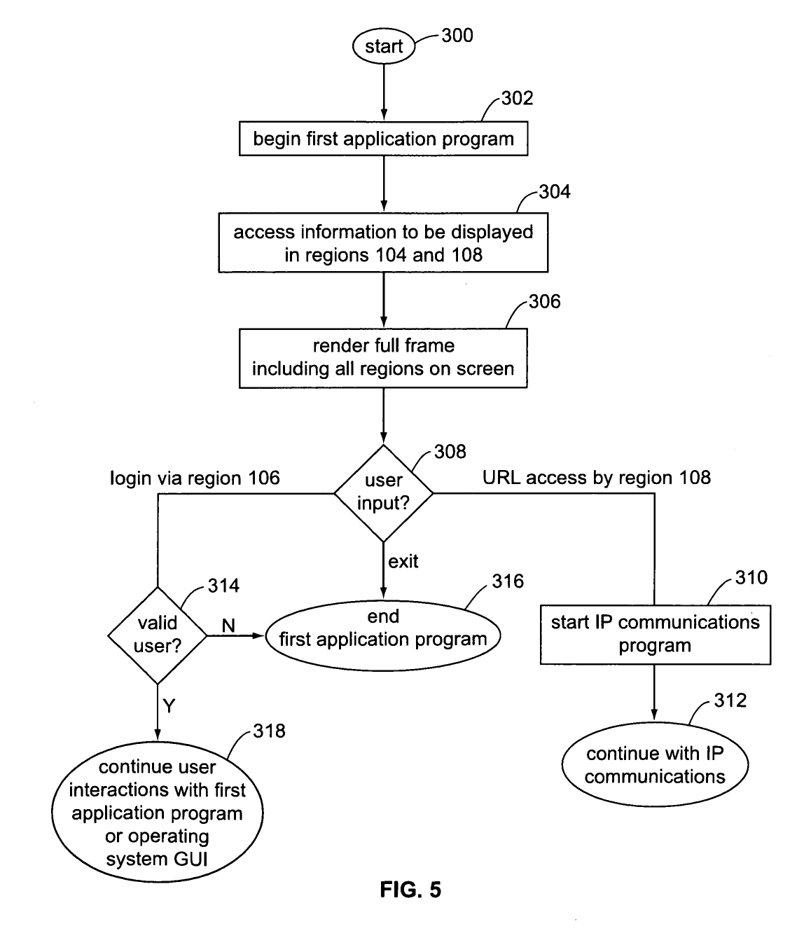

FIG. 5 is a flow diagram of steps in accordance with an exemplary method in accordance with the present invention illustrating the creation of the login screen and interaction with user input upon presentation of the login screen. Following the beginning of the method with START 300, the first application program running on the user's mobile device is launched as indicated at step 302 based on an input by the user. This may consist of the user clicking on an icon displayed on a screen with a plurality of icons, where the selected icon is associated with the first application program. In step 304 the mobile device accesses information to be displayed in regions 104 and 108 of the screen. This information may be accessed from local memory in the mobile device, from storage at a remote server accessed by a communication link with the mobile device, or combination thereof. Because the information displayed in region 106 is associated with the required login to the first application program, this information will normally be contained within the first application program itself or at a memory location known to the first application program. In step 306 the mobile device causes the full screen frame to be rendered with all regions based on the acquired information.

In step 308 a determination is made of whether a user input has been received. If the user input is a selection by the user of a URL address contained in region 108, step 310 results in the starting of an IP communications program, e.g. a browser resident on the mobile device, to initiate communications in accordance with the hyperlink associated with the URL address. In step 312 the communications program facilitates normal communications between the user's mobile device and a remote web server. If the input by the user is the entry of the login identification and password, followed by a request to be validated by the user, a determination is made in step 314 of whether a valid user entry has been made, i.e. authentication of a registered user. A NO determination by step 314 results in the first application program ending as indicated at step 316, or alternatively granting the user another chance to enter valid user identification. It will also be noted, that the user may enter an input as indicated at step 308 that will directly cause an exit from the first application program. A YES determination by step 314, indicating that the user login information has been validated, results in the first application program passing control to another application or a default operating system interface such as a screen of selectable icons so that further interactions with the user are facilitated as per step 318.

The mobile device in one example employs one or more computer-readable signal-bearing tangible media. The computer-readable signal-bearing media store software, firmware and/or assembly language for performing one or more portions of one or more embodiments of the invention. The computer-readable signal-bearing medium for the mobile device in one example may comprise ROM, other non-volatile electronic memory, RAM or media such as floppy disks, magnetic tapes, CD-ROMs, DVD-ROMs, and hard disk drives read by an external source such as a computer or server that transfers the computer instructions contained thereon to the mobile device.

Although exemplary implementations of the invention have been depicted and described in detail herein, it will be apparent to those skilled in the art that various modifications, additions, substitutions, and the like can be made without departing from the spirit of the invention. For example, the screen may be divided into 2 or more regions in a similar way to the 3 regions explained above. The regions may not control all of the possible screen area. For example, a bottom or top portion of the screen, e.g. 20%, may be controlled by a process independent of the regions, where this 20% is always dedicated to the same information, e.g. scrolling stock ticker, news, etc. In this example the regions will subdivide the remainder of the screen, e.g. the other 80%, into the regions. The application program that determines the regions to be utilized may also comprise a communications program which communicates with a remote server and receives some or all of the information to be rendered in the regions from the remote server. The information to be displayed in the regions can be accessed and stored in memory at the mobile device prior to a user request giving rise to the rendering of the login screen or can be accessed after the user's request causing the login screen to be rendered.

The scope of the invention is defined in the following claims.

We claim:

1. A method for controlling the display of information on the screen of a mobile device comprising the steps of:
(a) displaying, on a first region of the screen, first login request information generated under the control of a first application program from a first source, user input replying to the login request information to be utilized to validate a user as having been previously registered via the first application program as an authorized user;
(b) accessing second and third information obtained from second and third sources, respectively, where the content of the second and third information is controlled independent of the first application program;
(c) displaying the second and third information within second and third regions of the screen, respectively, the first, second and third information being concurrently displayed to the user in the first, second and third regions while awaiting a reply by the user to the first login request information, each of said regions occupying separate predetermined nonoverlapping horizontal segments of the screen, where information obtained from the second and third sources exclusively define information to be displayed in the second and third segments, respectively.

2. The method of claim 1 wherein the second and third sources also exclusively define the location within the second and third segments where the respective information will be displayed.

3. The method of claim 1 wherein the third source comprises a content provider and wherein the accessing of the third information comprises communicating with an Internet-based server operated by the content provider to access the third information.

4. The method of claim 3 wherein the third information comprises hypertext linked indicia and in response to activation by the user of the hypertext linked indicia, the mobile device causing the first application program to be terminated and an IP communication program to initiate communications with an external device to which the hypertext linked indicia is associated.

5. The method of claim 1 wherein the first application program receives the second and third information, and controls the generation the information shown in the first, second and third regions of the screen but without authority to alter the content of information displayed in the second and third regions.

6. The method of claim 1 wherein the third source comprises a server operated by a purveyor of Internet advertising, the third information comprising hypertext linked indicia, and wherein accessing the third information comprises communicating with an Internet-based server operated by a content provider associated with the hypertext linked indicia.

7. The method of claim 1 wherein an operating system receives the first, second and third information, and controls the generation the information shown in the first, second and third regions of the screen but without authority to alter the content of information displayed in the second and third regions.

8. A wireless mobile device having a screen for displaying information comprising:
a microprocessing unit controls the display, on a first region of the screen, of first login request information generated under the control of a first application program from a first source, user input replying to the login request information to be utilized to validate a user as having been previously registered via the first application program as an authorized user;
memory coupled to the microprocessing unit, the microprocessing unit accessing second and third information obtained from second and third sources, respectively, where the second and third information is accessed and stored in the memory;
the microprocessing unit controlling the display of the second and third information within second and third regions of the screen, respectively, the first, second and third information being concurrently displayed to the user in the first, second and third regions while awaiting the reply by the user to the first login request information, each of said regions occupying separate predetermined nonoverlapping horizontal segments of the screen, the microprocessing unit causing the second and third information obtained from the respective second and third sources to exclusively define information displayed in the respective second and third segments, respectively, with the first application program being prohibited from altering the content of the display of the second and third information.

9. The mobile device of claim 8 wherein the microprocessing unit prohibits the first application program from altering the location of the display of the second and third information within the respective second and third regions of the screen.

10. The mobile device of claim 8 wherein the third source comprises a content provider and wherein the accessing of the third information comprises the microprocessing unit communicating with an Internet-based server operated by the content provider to access the third information.

11. The mobile device of the claim 10 wherein the third information comprises hypertext linked indicia, and in response to activation by the user of the hypertext linked indicia, the microprocessing unit causing the first application program to be terminated and an IP communication program to initiate communications with an external device to which the hypertext linked indicia is associated.

12. The mobile device of claim 8 wherein the third source comprises a server operated by a purveyor or Internet advertising, the third information comprising hypertext linked indicia, and wherein accessing the third information comprises the microprocessing unit communicating with an Internet-based server operated by a content provider associated with the hypertext linked indicia.

13. The mobile device of claim 8 wherein the microprocessing unit has an operating system that receives the first, second and third information, and controls the generation the information shown in the first, second and third regions of the screen.

14. A computer readable storage medium containing instructions for the operation of a microprocessing unit of a wireless mobile device, the medium comprising:
computer readable storage instructions for displaying, on a first region of the screen, first login request information generated under the control of a first application program from a first source, user input replying to the login request information to be utilized to validate a user as having been previously registered via the first application program as an authorized user;
computer readable storage instructions for accessing second and third information obtained from second and third sources, respectively, where the content of the second and third information is controlled independent of the first application program;
computer readable storage instructions for displaying the second and third information within second and third regions of the screen, respectively, the first, second and third information being concurrently displayed to the user in the first, second and third regions while awaiting a reply by the user to the first login request information, each of said regions occupying separate predetermined nonoverlapping horizontal segments of the screen, the first application program being prohibited from altering the content of the display of the second and third information.

15. The computer readable storage medium of claim 14 further comprising computer readable storage instructions for prohibiting the first application program from altering the location of the display of the second and third information in the respective second and third regions of the screen.
